(19) United States
(12) Patent Application Publication
(10) Pub. No.: US 2005/0079621 A1
(43) Pub. Date: Apr. 14, 2005

(54) Liquid transfer system

(75) Inventors: Stuart Elmes, Coton (GB); Jonathan Pearson, March (GB); Alastair Taylor, Histon (GB); Colin Reynolds, Haverhill (GB); Dan Aldridge, St. Ives (GB)

Correspondence Address: Lawrence M. Green;Wolf, Greenfield & Sacks, P.C., 600 Atlantic Avenue, Boston, MA, 02210, US

(73) Assignee: BioRobotics, Ltd., Haslingfield (GB)

(21) Appl. No.: 10/655,714

(22) Filed: Sep. 5, 2003

(30) Foreign Application Priority Data
Jan. 31, 2003 (GB) 0302281.1

(51) Int. Cl. G01N 35/00

(52) U.S. Cl. 436/43; 422/100; 422/63; 436/49

(57) ABSTRACT

A liquid transfer pin is disclosed for transferring controlled volumes of a liquid from a distal end thereof to a substrate. The liquid transfer pin may be a ceramic, capillary pin. The pin of this invention may be used in micro-array printing. The capillary has a diameter which is at a minimum at the tip of the pin, but may be of uniform diameter along the whole length of the pin. A distal portion of the capillary may be selectively open in at least one radial direction to overcome problems associated with blocking. A robotic device for automatically filling the capillary pin of a liquid transfer tool is also disclosed. The robotic device fills the pin by lowering it into a source of liquid. The robotic device may include means for detecting the depth to which the capillary pin is dipped into the source of liquid. The robotic device also may be programmed to determine the length of time which the tip of the pin is to be held in the source of liquid. A method of operating a robotic device for filing a capillary pin is also disclosed. Furthermore, a method of cleaning a liquid transfer tool having an array of capillary pins is disclosed.

The present invention relates to liquid transfer systems incorporating capillary pins for depositing small amounts of fluid onto substrates. In particular, the present invention relates to liquid transfer systems for use in the field of cDNA, oligonucleotide or protein microarray printing.

A microarray generally consists of thousands of reagents, arranged in regular pattern on a surface, such as a coated microscope slide. One technique for manufacturing these patterns involves the deposition of small quantities of wet reagent onto the surface using contact printing. The solutions generally need to be deposited in a high density pattern, and therefore the drops volumes may need to be typically a nanoiltre (nL) or smaller. Each of the drops generally needs to be of substantially the same volume as its neighbour. This requires a deposition method that is precise and manufactured to a high tolerance. The buffer solution in which the reagents are stored may vary in volatility and in the size and number of particulates contained. Typically the solutions are also expensive requiring as small as possible pickup and also minimal wastage of material due to evaporative loss.

Probably the most important feature of the deposition technique is the reliability. The manufacture of microarrays is largely automated, with no live quality control and therefore if for some reason a deposition tool has stopped functioning that final microarray will be incomplete.

It is an aim of the present invention to provide a capillary pin that provides improved performance in a liquid transfer system.

It is another aim of the present invention to provide an improved holder for a capillary pin in a liquid transfer system.

It is another aim of the present invention to provide an improved robotic device for the filling of capillary pins in a liquid transfer system.

It is another aim of the present invention to provide an improved method of cleaning a capillary pin in a liquid transfer system.

The present invention provides a ceramic pin for transferring controlled volumes of a liquid from a tip thereof to a substrate, the ceramic pin defining a through hole extending to said tip, wherein the diameter of the through hole is at a minimum at said tip of the pin. In one embodiment, the through hole is of a uniform diameter along the whole length of the pin.

The present invention also provides a ceramic pin for transferring controlled volumes of a liquid from a tip thereof to a substrate, the ceramic pin defining a capillary for holding liquid, wherein the capillary extends to said tip of the pin.

The present invention also provides a ceramic pin for transferring controlled volumes of a liquid from a tip thereof to a substrate, the tip of the pin having a face angle of less than four degrees, preferably substantially zero degrees.

The present invention also provides a ceramic pin for transferring controlled volumes of a liquid from a tip thereof to a substrate, the tip of the pin defining a contact face substantially perpendicular to the longitudinal axis of the pin.

The present invention also provides a liquid transfer pin for transferring controlled volumes of liquid from a distal end thereof to a substrate, wherein the pin defines a longitudinal capillary for holding liquid, a distal portion of the capillary being selectively open in at least one radial direction.

The present invention also provides a liquid transfer pin for transferring controlled volumes of liquid from a distal end thereof to a substrate, wherein the pin defines a longitudinal capillary for holding liquid, a distal portion of the capillary being selectively adapted for preventing blockage by particulates.

The present invention also provides a liquid transfer pin for transferring controlled volumes of liquid from a distal end thereof to a substrate, wherein the pin defines a longitudinal capillary for holding liquid, a distal portion of the capillary being adapted to facilitate the removal of blockages.

The present invention also provides a use of a pin according to any preceding claim in a method of transferring to a substrate controlled volumes of a liquid, particularly a biological reagent such as polynucleotide sequences, distinct nucleic acid strands or proteins, by contacting the tip of the pin with the substrate.

The present invention also provides a liquid transfer tool including a liquid transfer pin defining a capillary for holding liquid and a holder for holding said pin in a predetermined manner, said holder including at a distal end thereof a longitudinal recess for receiving a proximal end of said pin, and including a radial vent hole in communication with said capillary via said recess.

The present invention also provides a robotic device for automatically filling at least one capillary pin of a liquid transfer tool by dipping the tip of the pin in a source of the liquid, wherein the speed at which the pin is dipped into the source of the fluid is adjustable.

The present invention also provides a robotic device for automatically filling at least one capillary pin of a liquid transfer tool by dipping the tip of the pin in a source of the liquid, wherein the length of time for which the tip of the pin is held in source of the fluid is adjustable.

The present invention also provides a robotic device for automatically filling at least one capillary pin of a liquid transfer tool by dipping the tip of the pin in a source of the liquid, wherein the volume of liquid taken up by the capillary is adjustable.

The present invention also provides a robotic device for automatically filling at least one capillary pin of a liquid transfer tool by lowering the pin into a source of the liquid to be transferred and then raising the pin out of the source of liquid, wherein the device includes means for detecting the depth to which the at least one capillary pin is dipped into the source of liquid, and wherein the robotic device is programmed to determine the length of time for which the tip of the pin is to be held in the source of fluid between the lowering and raising operations according to at least one parameter including the detected depth. In one embodiment, the depth to which the at least one capillary pin is dipped into the source of liquid is detected by measuring the level of the liquid surface with respect to a reference point.

The present invention also provides a method of operating a robotic device for filling at least one capillary pin of a liquid transfer tool by dipping the tip of the at least one capillary pin into a source of the liquid, the method including the steps of: storing in a memory of a computer of the robotic device data for determining the time for which the at least one capillary pin is to be dipped into the source of liquid; and inputting at a user interface one or more parameters relating to the desired pick-up volume; wherein the computer is operable to determine on the basis of said parameters the time for which the at least one capillary pin is to be dipped into the source of liquid.

The present invention also provides a robotic device for automatically filling at least one capillary pin of a liquid transfer tool by dipping the tip of the at least one capillary pin into a source of the liquid, wherein the robotic device includes a user interface for a user to input one or more parameters relating to the desired pick-up volume, and a computer that is operable to determine on the basis of said one or more parameters the time for which the at least one capillary pin is to be dipped into the source of liquid.

The present invention also provides a method of cleaning a liquid transfer tool including an array of capillary pins for transferring controlled volumes of liquid from tips thereof to a substrate, the method including inserting the tips of the pins into respective counterbores connected to a vacuum pump, each counterbore provided with a sealing ring, wherein the relative dimensions of the counterbores and the sealing rings are selected so as to allow for mis-alignments between the pins and the centre axes of the counterbores whilst ensuring a good seal between each counterbore and the respective pin.

The present invention also provides a ceramic capillary pin for transferring controlled volumes of liquid to a substrate surface by the method of filling the capillary pin with the liquid to be transferred, contacting the tip of the pin with the substrate surface and then distancing the tip of the pin from the substrate surface at least until the fluid ligament connecting the tip of the pin and the substrate surface is broken, wherein the capillary pin has a tip that is shaped so as to maximise the consistency of the position of the fluid ligament with respect to the pin axis.

Embodiments of the present invention are described hereunder, by way of example only, with reference to the accompanying drawings, in which:—

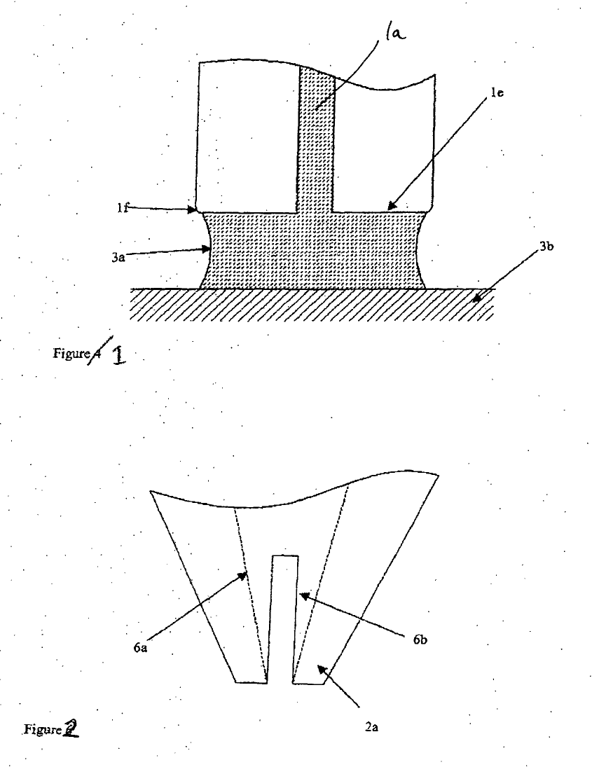

FIG. 1 is a cross-sectional view of the tip of a capillary pin according to an embodiment of the present invention in the process of transferring a controlled amount of liquid to a substrate surface;

FIG. 2 is a side view of the tip of a capillary pin according to another embodiment of the present invention;

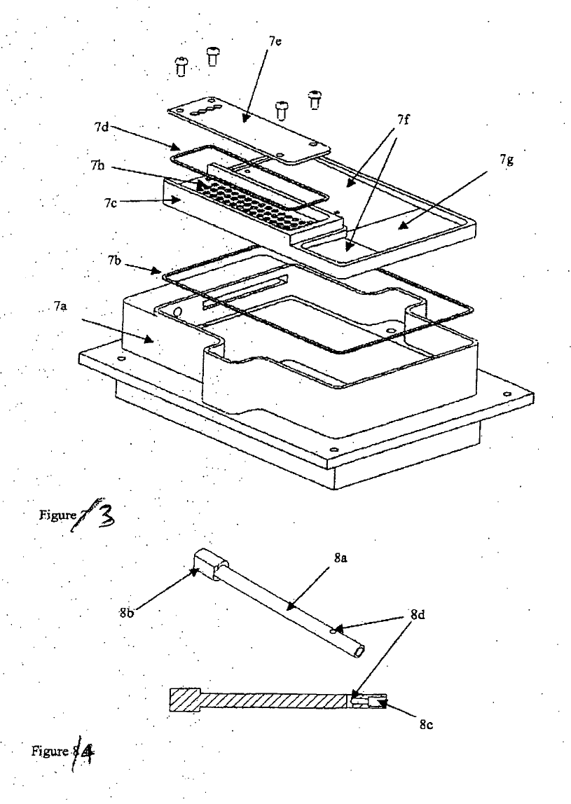

FIG. 3 is a perspective view of the parts of a tool adapted for use in a capillary pin cleaning method according to the present invention;

FIGS. 4(a) and 4(b) are respectively perspective and cross-sectional views of a capillary pin holder according to an embodiment of the present invention;

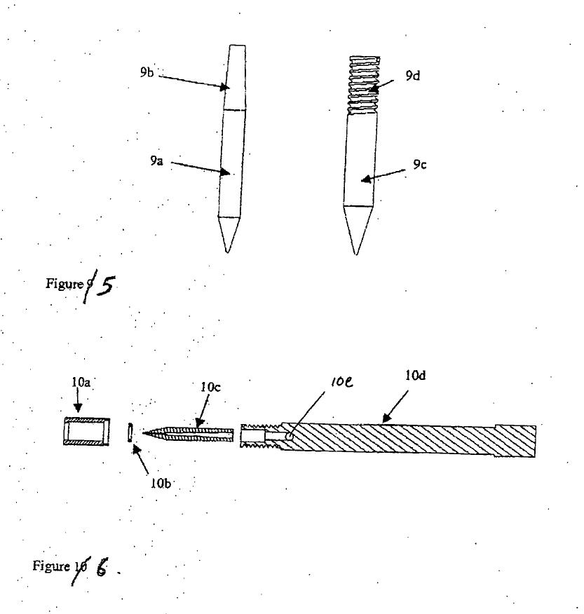

FIGS. 5(a) and 5(b) show examples of the types of capillary pins for use with the type of capillary pin holder shown in FIGS. 4(a) and 4(b).

FIG. 6 shows another example of a capillary pin holder according to the present invention; and

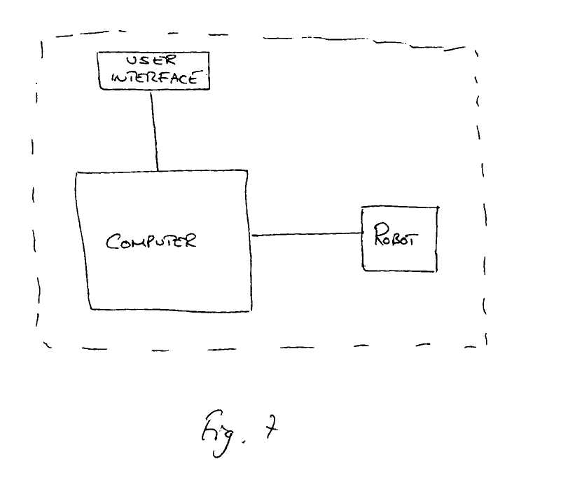

FIG. 7 shows a schematic view of an embodiment of a robotic device according to the present invention.

FIG. 1 shows the tip of a ceramic pin according to an embodiment of the present invention as it is being distanced from the target substrate in the latter stages of the process of transferring an amount of liquid on a substrate surface 3b. The through hole 1a (shown filled with liquid in FIG. 1) running the whole length of pin, which defines the internal capillary, extends to the tip 1e of the pin without any divergence towards the tip. In this way, the fluid meniscus of the fluid held in the capillary is in close proximity to the tip of the pin when the pin is brought towards the substrate to which liquid is to be transferred (a step prior to that shown in FIG. 1). This has the advantage that the liquid will be deposited onto any contacted surface by capillary action and this give excellent reliability.

As shown in FIG. 1, the tip of the pin is shaped so as to be substantially perpendicular to the longitudinal axis of the pin. This shape provides a relatively large area for the pin tip to contact the substrate. Experiments have shown that this reduces the stress experienced by the tip upon substrate contact and improves the liquid flow onto the substrate.

The outer radius 1f is minimised or made zero to improve the positional repeatability of the fluid ligament, 3a, position just prior to its break off during use. Experiments have shown that this is critical to control the volume of fluid transferred in each printing. Suggested values for the outer radius are ≦20% of the tip diameter, 1g.

Particularly with ceramic capillary pins having an internal capillary diameter at the tip of less than about 40 μm, it has been found to be advantageous to form an external slot 6b at the printing end of the pin, as shown in FIG. 2. This slot is provided to overcome the problems associated with blocking largely due to precipitates out of and/or particulates within the fluid blocking the flow of reagent from the tip to the substrate. It has been found that at present desirable feature sizes of <100 μm, which require an outside diameter of <130 μm, are not possible with a 40 μm internal capillary diameter pin as the tip is too fragile. One solution is to change the material the pins are made out of to a more robust material. The slot is provided to prevent particulates from blocking the capillary. The width of the slot is preferably 10-20 μm and its length is preferably 100-1000 μm. If the slot is too long there will be excessive evaporation from the slot. The external slot acts as an alternate path for the fluid to take to the substrate surface. Any blockages in the slot can be removed as it is open to the atmosphere. The external slot can be formed at the same time as forming the capillary pin or afterwards by machining using techniques known to those in the field such as laser micro-machining.

FIG. 3 shows an example of a wash system for use in a method of cleaning capillary pins according to the present invention. The system uses a vacuum pump connected to the main wash body 7a to draw air through the capillary for purposes of drying after washing. The wash station consists of a number of counter-bored holes in a plate 7c to which is mounted a gasket-sealed 7d top plate 7e with holes to correspond with the number of pins to be washed (for example 4). Into these holes are inserted O-rings, 7h, (which could be made from rubber or another suitable sealing material) that are of a smaller outside diameter than the counter-bore. The depth and/or width of the counterbore is greater than that of the cross-section diameter of the O-ring, 7h, such that the O-ring, 7h, is allowed to move freely within the bore. This allows for minor mis-alignments between the pins and the hole centres.

A capillary pin is inserted into the O-ring, 7h, and the vacuum pump switched on. This causes a flow of air through the capillary which dries the bore of the tip.

The wash station is sealed by virtue of a gasket 7b to minimize loss of vacuum. An excellent gasket material was found to be silicon sponge rubber as this is easily compressible and forms a good seal under vacuum without necessitating the use of threaded fasteners or other means of securing the plate.

The wash plate 7c incorporates tapered surfaces 7f to allow liquid overspill to drain onto a flat face 7g. A valve could be mounted into this flat face 7g to allow liquid to drain through but which closes when the vacuum is applied.

This sealed wash station works well for conventional microarraying pins (including quill/split or reservoir pins) as well as the new ceramic capillary pins described above, since flow across the pins is maximized.

With the above-described cleaning method, there is a reduced risk of any cleaning reagent being left in the pin when it is next used to draw up a new sample of biological reagent, which is desirable as any remaining cleaning agent would potentially dilute the biological reagent.

The cleaning system can be easily fitted to existing instrumentation with little or no effort.

FIGS. 4(a) and 4(b) show a device for holding the ceramic capillary pins described above that is compatible with existing microarray instrumentation and consumables. This device utilizes a metallic shaft 8a which incorporates a mounting hole 8c into which the ceramic capillary is inserted. The depth of the mounting hole is carefully maintained and referenced to the lower portion of the shaft head 8b so that deviations between overall lengths are minimized. The ceramic capillary is held in position by an adhesive bond that could be produced by means of an adhesive dispensing system incorporating a nozzle to produce an accurate bead. Other methods of ‘bonding’ the two surfaces could be used such as shrink-fitting or incorporating an interference fit. To assist washing and drying of the capillary, a cross-hole 8d opposes the mounting hole 8c such that it is possible for liquids or gases to flow through the top of the capillary and out the tip. This allows for thorough cleaning. The shaft diameter is sized such that it can enter into a standard or low profile 384- or 96-well microplate.

In one example, the external profile of the ceramic capillary pin is manufactured to enable easy mounting to a metallic shaft or similar. Two examples are shown in FIGS. 5(a) and 5(b). In FIG. 5(a), the proximal end of the pin is provided with a tapered portion 9b which could fit into a similarly shaped sleeve provided at the distal end of the holder in a “taper-lock” arrangement. The taper allows removal of the tip by virtue of driving the ceramic capillary downwards away from the mating tapered surfaces.

Another mounting example is shown in FIG. 5(b), where a thread 9d is provided at the proximal end of the ceramic capillary pin by moulding, machining or bonding. This allows the ceramic capillary pin to be easily screwed into a correspondingly adapted holder of the kind shown in FIGS. 4(a) and 4(b).

Another example of a holder according to the present invention is shown in FIG. 6. It is a two-part holder in which the two entities are fastened together by a thread. The ceramic capillary pin, 10c, is inserted into the shaft 10d against a shoulder. A flexible ring 10b is pushed over the ceramic capillary, 10c, and the fastener 10a is screwed onto the shaft 10d. As the fastener 10a is tightened, the tapered feature in 10a clamps down on the ring 10b which is compressed onto the ceramic capillary, 10c. As with the holder shown in FIGS. 4(a) and 4(b), a radial vent hole 10e is provided to facilitate the cleaning of the capillary bore by the vacuum technique described above.

With the holders described above, the ceramic capillary can be held in a way compatible with current microarray consumables and instrumentation whilst allowing thorough decontamination procedures. Also, the positions of the tips of the pins can be well controlled such that variations can be kept to an absolute minimum. Furthermore, sufficient clearance can be maintained between the tip holder and the microarray consumables; for example, the holder should have a nominal maximum diameter of no more than approximately 2.4 mm for a 384-well microplate. Pin deviations can be minimized to avoid producing mis-aligned microarrays and to eliminate any risk of arrays overlapping. Also the holder can be used on a conventional robotics platform used to manufacture microarrays.

With the ceramic capillary pins of the present invention, the sample fluid is picked-up into the device using capillary action. This is preferably done automatically using a robotic device to lower the tip of the pin into a source of the liquid and then raise it out of the liquid source. The volume picked-up depends upon the time spent in the fluid and the fluid properties, in particular the viscosity and the surface tension. By knowing the depth of the source fluid, speed of travel in the fluid and the rate of fill for the ceramic capillary, it is possible to determine the volume of fluid picked-up by the ceramic capillary. With reference to schematic FIG. 10, in a method of operating a robotic device according to the present invention, parameters such as the amount of fluid in the microarray consumable and pick-up volume required to print the required number of spots are entered by the user of the instrumentation via a user interface (such as a keypad) into a software algorithm stored in a computer. Alternatively, these parameters are automatically determined by the instrumentation, for example by automatically determining the depth of the fluid in the microarray consumables and calculating the number of depositions and hence pick-up volume required. A set-up file with calibration data for different fluids with different rates of capillary fill could be supplied along with a user accessible calibration feature for pick-up and dispense of non-standard reagents. A typical procedure could be:
User defines required microarray pattern
Algorithm calculates required number of depositions of each reagent to manufacture the microarray.
Algorithm calculates the required pick-up volume.
Algorithm reads set-up file for the appropriate fluid to be picked-up and deposited.
Algorithm calculates the appropriate dynamics required for the ceramic capillaries to pick-up the required volume of reagent.

Using the above technique the volume of reagent used to manufacture the microarray is minimized as the robot is controlled by the computer such that it holds the tip of the pin in the liquid source only as long as is required to pick-up the volume needed to print the microarray.

The applicant draws attention to the fact that the present invention may include any feature or combination of features disclosed herein either implicitly or explicitly or any generalisation thereof, without limitation to the scope of any definitions set out above. In view of the foregoing description it will be evident to a person skilled in the art that various modifications may be made within the scope of the invention. In particular, the present invention also resides in the combination of the features of any two or more of the accompanying claims.

1. A liquid transfer pin for transferring controlled volumes of a liquid from a tip thereof to a substrate, the pin defining a through hole extending to said tip, wherein the diameter of the through hole is at a minimum at said tip of the pin.

2. The pin according to claim 1, wherein the through hole is of a uniform diameter along the whole length of the pin.

3. The pin according to claim 1, wherein the through hole is a capillary for holding liquid.

4. The pin according to claim 1, wherein the tip of the pin has a face angle of less than four degrees.

5. The pin according to claim 4, wherein the face is substantially perpendicular to the longitudinal axis of the pin.

6. The pin according to claim 3, wherein a distal portion of the capillary is selectively open in at least one radial direction.

7. The pin according to claim 3, wherein a distal portion of the capillary is selectively adapted for preventing blockage by particulates.

8. The pin according to claim 3, wherein a distal portion of the capillary is adapted to facilitate the removal of blockages.

9. (canceled)

10. (canceled)

11. (canceled)

12. (canceled)

13. A liquid transfer tool including a liquid transfer pin defining a capillary for holding liquid and a holder for holding said pin in a predetermined manner, said holder including at a distal. end thereof a longitudinal recess for receiving a proximal end of said pin, and including a radial vent hole in communication with said capillary via said recess.

14. A robotic device for automatically filling at least one capillary pin of a liquid transfer tool by dipping the tip of the pin in a source of the liquid, wherein one or more parameters related to a desired pick-up volume are adjustable.

15. The robotic device according to claim 14, wherein the length of time for which the tip of the pin is held in a source of the liquid is adjustable.

16. The robotic device according to claim 14, wherein the volume of liquid taken up by the capillary is adjustable.

17. A robotic device for automatically filling at least one capillary pin of a liquid transfer tool by lowering the pin into a source of the liquid to be transferred and then raising the pin out of the source of liquid, wherein the device includes a detector for detecting the depth to which the at least one capillary pin is dipped into the source of liquid, and wherein the robotic device is programmed to determine the length of time for which the tip of the pin is to be held in the source of liquid between the lowering and raising operations according to at least one parameter including the detected depth.

18. A robotic device according to claim 17, wherein the depth to which the at least one capillary pin is dipped into tile source of liquid is detected by measuring the level of the liquid surface with respect to a reference point.

19. A method of operating a robotic device for filling at least one capillary pin of a liquid transfer tool by dipping the tip of the at least one capillary pin into a source of the liquid, the method including the steps of. storing in a memory of a computer of the robotic device data for determining the time for which the at least one capillary pin is to be dipped into the source of liquid; and inputting at a user interface one or more parameters relating to the desired pick-up volume; wherein the computer is operable to determine on the basis of said parameters the time for which the at least one capillary pin is to be dipped into the source of liquid.

20. The robotic device according to claim 14, wherein the robotic device includes a user interface for a user to input one or more parameters relating to the desired pick-up volume, and a computer that is operable to determine on the basis of said one or more parameters the time for which the at least one capillary pin is to be dipped into the source of liquid.

21. A method of cleaning a liquid transfer tool including an array of capillary pins for transferring controlled volumes of liquid from tips thereof to a substrate, the method including inserting the tips of the pins into respective counterbores connected to a vacuum pump, each counterbore provided with a sealing ring, wherein the relative dimensions of the counterbores and the sealing rings are selected so as to allow for misalignments between the pins and the centre axes of the counterbores whilst ensuring a good seal between each counterbore and the respective pin.

22. A ceramic capillary pin for transferring controlled volumes of liquid to a substrate surface by the method of filling the capillary pin with the liquid to be transferred, contacting the tip of the pin with the substrate surface and then distancing the tip of the pin from the substrate surface at least until the fluid ligament connecting the tip of the pin and the substrate surface is broken, wherein the capillary pin has a tip that is shaped so as to maximise the consistency of the position of the fluid ligament with respect to the pin axis.

23. The pin according to claim 1, wherein the pin is ceramic.

24. The pin according to claim 4, wherein the face angle is substantially zero degrees.

25. The robotic device according to claim 14, wherein a speed at which the pin is dipped into the source of the liquid is adjustable.
